(19) United States
(12) Patent Application Publication
(10) Pub. No.: US 2025/0156631 A1
(43) Pub. Date: May 15, 2025

(54) APPARATUS FOR SYNTHETIC DATA GENERATION

(71) Applicant: Genpact USA, Inc., New York, NY (US)

(72) Inventors: Anirudh Sharma, New Delhi (IN); Mohit Pawar, Uttarakhand (IN); Ramkumar B, Andhra Prades (IN); Akarsh Rastogi, Jharkhand (IN); Ravi Kumar, Bangalore (IN); Chirag Jain, Bangalore (IN); Sreekanth Menon, Bangalore (IN)

(21) Appl. No.: 18/506,235

(22) Filed: Nov. 10, 2023

(51) Int. Cl. G06F 40/20

(52) U.S. Cl. CPC G06F 40/20

(57) ABSTRACT

In an embodiment, an apparatus for synthetic data generation is presented. The apparatus includes a processor and a memory communicatively connected to the processor. The memory contains instructions configured to the processor to receive data. The processor is configured to input the data into a generative framework. The generative framework includes a first category of synthetic data generation and a second category of synthetic data generation. The generative framework is configured to input data an output synthetic data through at least a category of synthetic data generation. The processor is configured to generate, based on the generative framework, synthetic data from the received data.

### TECHNICAL FIELD

This disclosure relates to apparatuses and methods for data generation. In particular, the current disclosure relates to synthetic data generation using generative artificial intelligence frameworks.

### BACKGROUND

Artificial Intelligence (AI) and Machine Learning (ML) utilize vast amounts of data. Data generation to train these AI and ML models can be improved.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment, an apparatus for synthetic data generation is presented. The apparatus includes a processor and a memory communicatively connected to the processor. The memory contains instructions configured to the processor to receive data. The processor is configured to input the data into a generative framework. The generative framework includes a first category of synthetic data generation and a second category of synthetic data generation. The generative framework is configured to input data and output synthetic data through at least a category of synthetic data generation. The processor is configured to generate, based on the generative framework, synthetic data from the received data.

In another embodiment, a method of synthetic data generation using a computing device is presented. The method includes receiving data and inputting the data into a generative framework. The generative framework includes a first category of synthetic data generation and a second category of synthetic data generation. The generative framework is configured to input data and output synthetic data through at least a category of synthetic data generation. The method includes generating, based on the generative framework, synthetic data from the received data.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 is an exemplary embodiment of a block diagram of an apparatus for synthetic data generation;

FIG. 2 shows a flowchart of an exemplary embodiment of a method of synthetic data generation;

FIGS. 3A-D depict graphs of synthetic data generation using various Gen AI architectures;

FIGS. 4A-D illustrate correlation matrices of various synthetic data generation outputs of generative AI architectures;

FIG. 5 is an exemplary embodiment of a generative adversarial network (GAN);

FIG. 6 illustrates an exemplary embodiment of a neural network;

FIG. 7 illustrates an exemplary embodiment of a node of a neural network; and

FIG. 8 illustrates an exemplary embodiment of a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted

### DETAILED DESCRIPTION OF EXEMPLARY EMBODIMENTS

With significant advancements in the field of Artificial Intelligence (AI) and Machine Learning (ML), data has often been referred to as the “new oil”. However, AI/ML models are data-hungry and require a significant amount of data to train on and produce useful outputs. At a high level, aspects of the present disclosure can be used to generate synthetic data generation for use in AI/ML models. In another embodiment, aspects of the present disclosure can be used to produce synthetic data that is anonymized while retaining inter-table referential data. In yet another embodiment, aspects of the present disclosure can allow for a hybrid framework that combines two or more methods of generating structured synthetic data under one generative framework, for instance, combining a hierarchical modeling algorithm (HMA) with a distribution based approach.

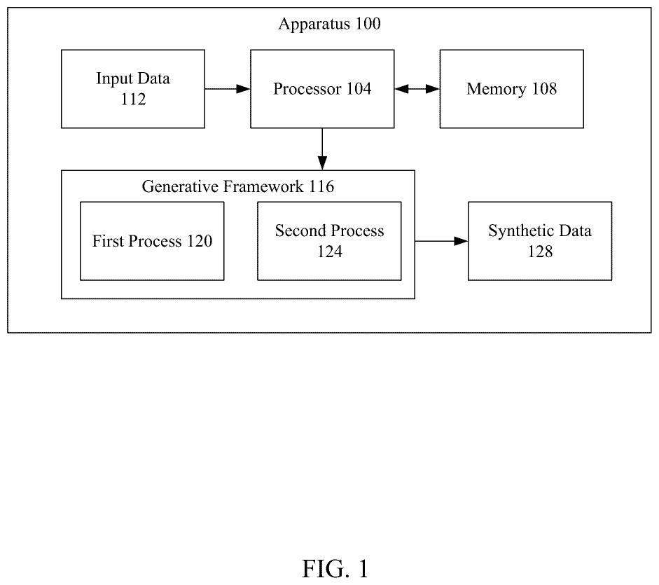

Referring now to FIG. 1, an apparatus 100 for synthetic data generation is presented. The apparatus may include disk storage and/or internal memory, each of which may be communicatively connected to each other. Apparatus 100 may include a processor 104. The processor 104 may enable both generic operating system (OS) functionality and/or application operations. The apparatus 100 may include a memory 108, such as random access memory (RAM). The memory 108 may include instructions configuring the processor 104 to perform various tasks. In some embodiments, the processor 104 and the memory 108 may be communicatively connected. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 104 may include any computing device as described in this disclosure, including without limitation a microcontroller, microprocessor, digital signal processor (DSP) and/or system on a chip (SoC) as described in this disclosure. The processor 104 may include, be included in, and/or communicate with a mobile device such as a mobile telephone or smartphone. The processor 104 may include a single computing device operating independently, or may include two or more computing device operating in concert, in parallel, sequentially or the like; two or more computing devices may be included together in a single computing device or in two or more computing devices. The processor 104 may interface or communicate with one or more additional devices as described below in further detail via a network interface device. Network interface device may be utilized for connecting the processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 104 may include but is not limited to, for example, a computing device or cluster of computing devices in a first location and a second computing device or cluster of computing devices in a second location. The processor 104 may include one or more computing devices dedicated to data storage, security, distribution of traffic for load balancing, and the like. The processor 104 may distribute one or more computing tasks as described below across a plurality of computing devices of computing device, which may operate in parallel, in series, redundantly, or in any other manner used for distribution of tasks or memory between computing devices. The processor 104 may be implemented using a “shared nothing” architecture in which data is cached at the worker, in an embodiment, this may enable scalability of apparatus 100 and/or computing the processor 104.

With continued reference to FIG. 1, processor 104 and/or a computing device may be designed and/or configured by memory 108 to perform any method, method step, or sequence of method steps in any embodiment described in this disclosure, in any order and with any degree of repetition. For instance, the processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, the processor 104 may be configured to receive data 112. Data 112 may include any form of data, such as, but not limited to, characters, strings, numerical values, dates, and the like. The data 112 may be communicated to the processor 104 over a wireless, wired, or other connection. In some embodiments, the data 112 may be sent to the processor 104 through an external computing device, such as, but not limited to, a laptop, server, desktop, tablet, and the like. The data 112 may include one or more datasets. Datasets of the data 112 may include any form of data, such as medical data, health data, shipping data, and and/or other categories of data, without limitation. Medical data may include disease, conditions, ailments, therapies, medicines, diagnoses, and the like. Health data may include weights, heights, ages, blood pressures, heart rates, heart rhythms, nutrient quantities, cholesterol levels, and the like. Shipping data may include origins, destinations, routes, package values, fuel used, route stops, and the like. The data 112 may be tabular, such as, but not limited to, having one or more columns, rows, and correlations between columns and rows. In some embodiments, the data 112 may include, without limitation, employee survey datasets, employee demographic data, subscribed policies, and the like.

In some embodiments, the data 112 may include relational data. Relational data may be data that refers to two or more tabular datasets, such as, without limitation, names, dates, numerical values, characters, strings, identification numbers, and the like. As a non-limiting example, relationship data may include a column of names of one dataset that may correspond to a column of names of a second dataset. In some embodiments, the data 112 may have one or more primary keys and/or foreign keys. A primary key refers to a value or values that may be used to ensure that data in a specific column is unique. A foreign key refers to a value or values of one or more columns in a relational database table that provides a link between data in two tables. In other words, a foreign key may be a column that references a column of another data table.

The data 112 may have a plurality of relational data between a plurality of datasets. For instance, and without limitation, the data 112 may have relational data between three or more datasets. In some embodiments, the data 112 may be categorized into one or more categories. Categorization may occur via the processor 104. For instance, the processor 104 may categorize or otherwise pre-process the data 112 for use in the generative framework 116. Categories of the data 112 may include categorical variables, numeric variables, date variables, and/or free text variables. A free text variable may include text that is unfixed with one or more values. For instance and without limitation, free text variables may include prescriptions, addresses, user comments, customer feedback, and the like. The data 112 may belong to a combination class. A combination class may be a unique combination of all categorical variables. For instance a combination class may include multiple variables such as, but not limited to, month and year of date variables. In some embodiments, the processor 104 may receive the data 112 in a pre-categorized form.

Referring still to FIG. 1, the processor 104 may be configured to receive the data 112, such as from, but not limited to, a wired, wireless, or other connection. In some embodiments, the data 112 may initially be residing in a storage device of the apparatus 100. In other embodiments, the data 112 may be communicated to the processor 104 from one or more external computing devices. The data 112 may be used as input into a generative framework 116. The processor 104 may be configured to generate a generative framework 116. In some embodiments, the generative framework 116 may be operating on a device outside of the apparatus 100, in which the processor 104 may communicate with the generative framework 116 over a wired, wireless, or other connection. The generative framework 116 may include one or more data processes that may be configured and/or programmed to output synthetic data 128 based on real world data. Synthetic data 128 is artificially generated data that may take place of real-world data, such as the data 112. For instance, the synthetic data 128 may be anonymized, artificially generated data of the data 112. As a non-limiting example, the synthetic data 128 may be artificially generated data of the data 112 without actually making a copy of the data 112 but ensuring similar distributions and characteristics of the data 112. In some embodiments, the synthetic data 128 may be generated from the data 112.

The generative framework 116 may be configured to input the data 112 and output synthetic data 128 through one or more processes. The generative framework 116 may include a first process of synthetic data generation 120 and a second process of synthetic data generation 124. In some embodiments, there may be three or more processes of the generative framework 116. The first process of synthetic data generation 120 may include a first category of synthetic data generation. A first category of the first process 120 may include a generative artificial intelligence (Gen AI) architecture. Gen AI architectures of the first process 120 may include, without limitation, Gaussian Copulas, Tabular generative adversarial network (TGAN), Conditional Tabular generative adversarial network (CTGAN), CopulaGAN, Tabular Variational Autoencoder (TVAE), and the like.

A Gaussian Copula refers to a mathematical object that may capture a dependence structure between random variables. A Gaussian copula may be a type of copula function that may be used to model a joint distribution of random variables. In some embodiments, a Gaussian copula may be constructed by transforming marginal distributions of variables into standard normal distribution and using a joint distribution of the standard normal variables to define a dependence structure between the original variable sin input data. In some embodiments, Gaussian copulas may be extended to model multivariate dependencies while modeling both positive and negative correlations between variables.

A Tabular GAN refers to a GAN algorithm for tabular data augmentation. A GAN may include a generator and a discriminator. A generator may generate synthetic data and try to device a discriminator. A discriminator may try to discriminate whether the data generated by the generator is real data or synthetic data. In some embodiments, in the Tabular GAN, each numerical variable may be trained by a Gaussian Mixture Model (GMM) with components as a weighted sum of a normalized probability distribution over Gaussian distributions. For categorical variables of the Tabular GAN, a discrete variable may be first represented as an n-dimensional one-hot vector, with noise added to each dimension.

A Conditional Tabular GAN refers to an extended version of a TGAN. A generator of a TGAN may not consider an imbalance of categorical variables. In a CTGAN, a Variational Gaussian Mixture Model (VGM) may be utilized instead of a GMM for numerical variables. In the CTGAN, a Wasserstein GAN loss function may be used for a gradient penalty. For categorical variables in a CTGAN, a training-by-sampling, conditional vector, and/or a generator loss may be implemented for solving imbalance problems. In the training-by-sampling method a critic may estimate an output of the conditional generator.

A CopulaGAN refers to a type of GAN that models a joint distribution of data using copulas. In some embodiments, in contrast to traditional GANS, a CopulaGAN may provide a more flexible approach to modeling complex dependencies among variables. For instance, the generator of the CopulaGAN may generate samples from a copula distribution and the discriminator of the CopulaGAN may learn to distinguish between generated samples and real samples. A copula distribution may be constructed by transforming independent uniform random variables using a copula function that captures a dependency structure of the data.

A Tabular Variational Autoencoder (TVAE) refers to a generative model that is a type of neural network architecture. The TVAE may learn a low-dimensional latent representation of the input data and use this representation to generate new synthetic samples that have similar statistical properties as real data. The TVAE may be trained to learn a probability distribution of data by minimizing a loss function that may measure a difference between real data and generated samples. Advantageously, the TVAE may be configured to generate data samples that are more diverse and realistic than traditional generative models. In some embodiments, the TVAE may also be used to interpolate between different data samples, allowing for a generation of new data that may be a combination of existing samples. The above description of generative artificial intelligence architecture is not intended to be limiting and one of ordinary skill in the art, upon reading this disclosure, will appreciate the many generative AI models that may be used to generate synthetic data.

Referring still to FIG. 1, a user may select one or more Gen AI architectures of the first process 120 for a variety of purposes. For instance, a user may select a CopulaGAN architecture for the first process 120 to capture dependency structure of the data 112. Likewise, a user may select a TVAE to generate synthetic data 128 that is more diverse and realistic than other models due to the TVAE's neural network architecture. In some embodiments, the generative framework 116 may select a type of Gen AI architecture for the first process 120 automatically and/or may recommend a Gen AI architecture for a user. For instance, a CopulaGAN and/or TVAE may be selected to create synthetic data 128 that may be most congruent in statistical measures to the data 112. In an embodiment, a TGAN and/or CTGAN may be selected which may create deviating synthetic data 128 that may not overlap the data 112. A CopulaGAN may be selected for a reliable performance. For instance, the generative framework 116 may select a specific Gen AI architecture based on requirements for the synthetic data 128, the type of input data 112, size of the input data 112, thresholds of intra-table and/or inter-table integrity, and the like. Inter-table integrity refers to referential data between two or more data tables. Intra-table integrity refers to relationships between columns and rows within the data table.

The first process 120 of the generative framework 116 may include a two-part process. A two-part process of the first process 120 may include a first process of generating synthetic data 128 through a Gen AI architecture, such as described above. A second process of a two-part process of the first process 120 may include implementing a hierarchical modeling algorithm (HMA) with an initial or subsequent output of one or more Gen AI architectures. In other words, in some embodiments, the first process 120 may include one or more Gen AI architectures in conjunction with an HMA. HMA's may include one or more statistical modeling techniques that involve modeling data at multiple levels of a hierarchy, such as with a multilevel hierarchical distribution of one or more variables and/or classes. A hierarchy may include a form of data in which the data has a parent class and one or more child classes stemming from the parent class. For instance and without limitation, a hierarchy may include an initial data class of medical data with a child class of diagnoses which in itself may have a child class of sleep disorders which may further have a child class of sleep apnea. Each child class may represent a level of a hierarchy of a dataset. In a multilevel hierarchical distribution, such as an HMA, data may be grouped or clustered into different levels based on their similarities and/or relationships. Similarities may include one or more variables with similar contexts, such as, but not limited to, city name, geographic coordinates, identify variables such as patient identification, primary keys in a plan coverage table, foreign keys in a data table with personal information, and the like. Relationships may include one or more related groupings of variables. For instance and without limitation, a relationship may include a disease policy coverage variable that may be related to a disease type variable. Distributions of similarities and relationships within and/or across one or more data tables may be captured using configurable parameters while creating metadata. A statistical model may be developed for each level within a multilevel hierarchical distribution that may account for variation within and between groups. Synthetic data of an HMA may be combined at each level of a hierarchy to generate synthetic data 128 that preserves a hierarchical structure of the original data 112. For instance, continuing the example above, an HMA may combine synthetic data 128 at a hierarchical level that keeps the structure of the medical data parent class, diagnoses child class, sleep disorder child class, and sleep apnea child class, which may have originated from the data 112. The first process 120 may utilize the data 112 as input data and generate, through one or more Gen AI architectures and/or HMA's, synthetic data 128.

Referring still to FIG. 1, the generative framework 116, in the first process 120, may combine a Gen AI model with an HMA. For instance, the generative framework 116 may train a TGAN, CTGAN, TVAE, and/or CopulaGAN on an individual table of the data 112, a plurality of tables of the data 112, and the like. Training may involve using an original few data samples from a table of the data 112 to train one or more Gen AI models. In some embodiments, training one or more Gen AI models may include utilizing one or more constraints. Constraints during training of the above-listed models may be defined and fed into the one or more Gen AI models. Constraints may include, but are not limited to, fixed combinations, unique combinations, custom constraints, and the like. A fixed combination may include one or more categories of variables that may be maintained in the synthetic data 128. As a non-limiting example, if diabetes is covered in a policy type in the data 112, the synthetic data 128 may maintain a disease covered category and a policy type category which include diabetes. A custom combination constraint may include constraints on one or more columns and/or groups of columns. As a non-limiting example, a column titled “Plan Start Date” may come before a column titled “Plan End Date” in the data 112. A custom combination constraint may be that the synthetic data 128 may maintain the order of the columns in the data 112. In some embodiments, one or more hyperparameters may be tuned for the one or more Gen AI models. Hyperparameters may include, but are not limited to, learning rates, number of epochs, batch sizes, branches in decision trees, number of clusters in a clustering algorithm, train-test split ratio, k in a K-Nearest Neighbor algorithm, and the like. In some embodiments, the generate framework 116 may select and/or modify one or more constraints, hyperparameters, and the like. In other embodiments, a user may select one or more constraints, hyperparameters, and the like.

The generative framework 116 may utilize one or more language models to generate one or more free text variables. For instance, the generative framework 116 may utilize a large language model (LLM) to generate one or more variables, such as one or more free text variables. A large language model may be a foundation model that utilizes deep learning innatural language processing (NLP) and/or natural language generation (NLG) tasks. LLMs may include without limitation, BLOOM, NeMO LLM, XLM-ROBERTa, XLNet, Cohere, GLM-130B, and/or other custom build LLMs. An LLM may be pre-trained on vast amounts of data, using techniques such as fine-tuning, in-context learning, zero/one/few-shot learning, and the like. During a pretraining phase, an LLM may be exposed to a massive amount of semantic data, such as data from the internet, which may allow the LLM to learn patterns, relationships, and statistical information about language. The LLM may have an objective, such as to predict a next word in a sentence given the preceding context. The LLM may learn to understand grammar, syntax, semantics, and other linguistic nuances.

A pretrained LLM may consist of multiple layers of self-attention mechanisms, which may enable the LLM to capture dependencies between different words in a sentence. This architecture may help the LLM to consider the context of each word while generating text. Once the pretrained LLM is created, the LLM may be fine-tuned on specific tasks or domains. Fine-tuning may involve exposing the LLM to more targeted and specialized data to make it more proficient in a particular area, such as translation, question answering, or text completion. During the fine-tuning process, the LLM may be trained using supervised learning techniques. For instance, the LLM may be provided with input-output pairs, where the input could be a prompt or a question, and the output may be the expected text or answer, as a non-limiting example. The LLM may adjust its internal parameters to minimize a difference between a generated output and an expected output. After being trained, the LLM may be used to generate coherent and contextually relevant text. In application of the generative framework 116, an LLM may be configured to generate free-text variables relevant to the data 112. For instance, an LLM may be trained with training data relevant to the input data 112 and, in response to the training, may be configured to fill empty data slots with synthetic free text variables. Training of an LLM may include training historical text in combination with numerical and categorical variables of the input data 112.

In an embodiment, after generating the synthetic data 128, the generative framework 116 may apply an HMA to the synthetic data 128, such as without limitation a HMA1 algorithm, a Bayesian hierarchical modeling algorithm, and/or other algorithm. In some embodiments, meta data of one or more Gen AI architectures may be extracted by the processor 104. Extracted metadata may include combinations of the input data 112 that may be preserved and applied as metadata information to an HMA. The input data 112 may be preserved and applied as metadata information through one or more combination constraints. For instance, and without limitation, a constraints parameter may be applied while creating metadata which may maintain relationships among two or more variables. The processor 104 and/or the generative framework 116 may automatically extract combination and/or referential data of the input data 112. The extracted metadata may preserve referential integrity of the input data 112 when applied through an HMA. An HMA may be configured to be compatible with one or more Gen AI architectures, for instance and without limitation, by utilizing metadata of one or more outputs of one or more Gen AI architectures. In some embodiments, initial synthetic data 128 generated for each individual table of a plurality of data tables from one or more Gen AI architectures may be used as an input to an HMA. A user may select one or more constraints and/or hyper parameters for each level of a hierarchy of an HMA. The HMA may group and/or cluster the synthetic data 128 into one or more levels based on similarities, relationships, and the like of the synthetic data 128. In some embodiments, a user may select one or more constraints and/or hyper parameters for each level of a hierarchy of an HMA. Relationships in a hierarchy may be defined in one or more metadata files. In some embodiments, primary, composite, and/or foreign keys may be placed in metadata which may help maintain similar distributions across one or more tables.

The generative framework 116, alternatively or additionally, may utilize the second process 124, which may have a second category of synthetic data generation. For instance, the second process 124 may be a distribution driven approach. The second process 124, utilizing a distribution-based approach, may generate the synthetic data 128 while ensuring all combinations of variables are present exactly as in the original data 112 with their respective distributions. The second process 124 may maintain referential data integrity for either or both inter-table and/or intra-table relationships of the synthetic data 128. In some embodiments, the second process 124 may generate a summary of numerical variables by combination class for each table to capture the intra table information, such as combinations of values of categorical and date variables as described above. As a non-limiting example, a combination class may capture frequencies of values, means, standard deviations, different percentiles, Gaussian distribution, average day, average time stamp, average difference in date variables, and the like. The second process 124 may be configured to merge all different tables generated by a summary at a summarized level, such as by using an outer join function leveraging a foreign key of the data 112. A result of the second process 124 may be a summary of numerical variables by a joint combination class at an inter table level. In some embodiments, a summary of numerical variables by a joint combination class may be viewed as a normalized table at an aggregate level.

In some embodiments, the second process 124 may scale normalized data to generate the synthetic data 128 for each join combination class at a merged level. The synthetic data 128 may include new synthetic values of categorical variables, such as, but not limited to, member IDs, user IDs, and the like. The second process 124 may denormalize the synthetic data 128 per individual tables from a scaled merged table. Denormalization may include adding redundant data to one or more data tables, which may help avoid costly joins in a relational database. For instance, the synthetic data 128 for individual tables may be retrieved by keeping required individual table columns and combination classes. The second process 124 may create numerical and date values for respective columns. In the second process 124, synthetic data 128 may be generated for numerical numbers. For instance and without limitation, after a distribution is captured for each combination class and across different tables, the synthetic data 128 may be scaled up by generating numerical numbers for each combination class per distribution, without limitation. In another embodiment, the second process 124 may generate synthetic data 128 for day and/or time stamps of date variables. For instance, and without limitation, after a distribution is captured for each combination class and across tables, a day and time stamp of date variable may be generated based on a mean and standard deviation of the average days, average time stamp, and average difference between various date variables. A difference between different date variables may be maintained in the synthetic data 128.

Still referring to FIG. 1, the generative framework 116 and/or the processor 104 may be configured to validate the synthetic data 128. Validation may refer to comparing the synthetic data 128 against one or more metrics. Validation may include one or more metrics such as, but not limited to, variety, volume, and/or veracity. Variety may refer to instances were all unique combinations of categorical data in the input data 112 are present in the generated synthetic data 128. A threshold of variety may be employed, such as, but not limited to, 80%, 85%, 90%, 95%, and the like. A threshold for variety may be selected by a user, Gen AI, model, and/or a combination thereof. Volume may include validations at various levels of generated data, such as, but not limited to, at a granular level/combination class level. At a granular level/combination class level, generated synthetic data 128 for combinations may be in the same proportion/volume as the input data 112. Veracity may refer to referential integrity. For instance, the generated synthetic data 128 may maintain a same hierarchy of variables as present in the input data 112. As a non-limiting example, a hierarchy of variables may include columns having particular combinations of values, such as continent, country, state, and the like. Continuing this example, a data table may have a column containing data that Delhi is present in India which is present in Asia. Values in a hierarchy of variables may be maintained. For instance, continuing the above example, India in a country column may not be mixed with Antarctica in a continent column. Referential integrity of the data 112 may be maintained for both intra and inter table relationships in the synthetic data 128 generated through the first process 120 and/or the second process 124.

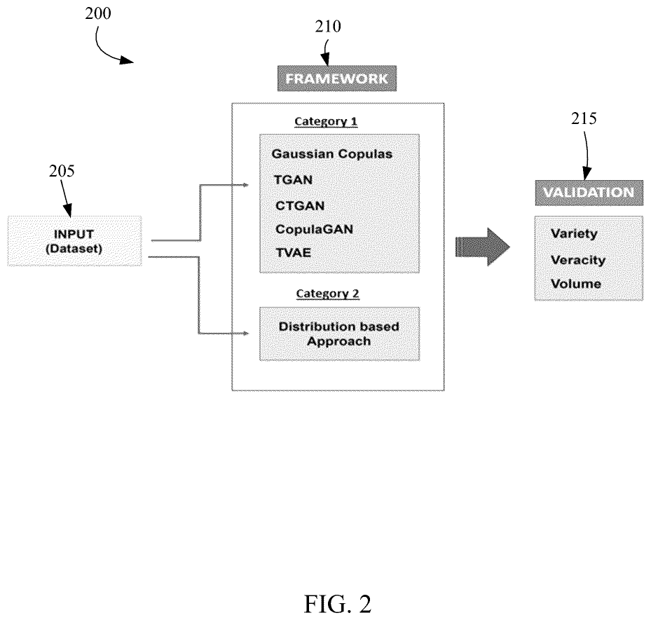

Referring now to FIG. 2, a flowchart 200 of an exemplary embodiment of synthetic data generation is presented. At step 205, an input data set is selected. An input dataset may include any form of data as described throughout this disclosure, such as the data 112 as described above. For instance and without limitation, the input dataset may include medical data, shipping data, health data, and/or any other type of data. The input data set may be categorized into one or more categories, such as, but not limited to, categorical variables, numerical variables, date variables, and/or free text variables. The input data may include one or more combination classes, which may include a unique combination of all categorical variables, including month and year of date variables. This step may be implemented as described above with reference to FIG. 1, without limitation.

At step 210, a method of synthetic data generation is selected. A method of synthetic data generation may be user selected. A method of synthetic data generation may be selected from a first category of synthetic data generation. A first category of synthetic data generation may include one or more Gen AI architectures and/or one or more Gen AI architectures combined with an HMA. A user may select a specific Gen AI architecture for a variety of purposes, such as data type, desired output data, thresholds in referential integrity, and the like. In some embodiments, a combination of two or more Gen AI architectures may be selected. A Gen AI architecture of a first category of synthetic data generation may input data and output synthetic data, as described above. The synthetic data may be input to an HMA. The HMA may take the synthetic data and output a clustering or grouping of the synthetic data by likeness, reference, and the like, such as described above with reference to FIG. 1. This step may be implemented as described above with reference to FIG. 1, without limitation.

In step 210, a user and/or a generative framework may select a second category of synthetic data generation alternatively to the first category of synthetic data generation. A second category of synthetic data generation may include a distribution-based approach. For instance, a distribution-based approach may include creating a summary of numerical variables by a combination class for each table of the input dataset to capture the intra-table information. A distribution-based approach may include merging all different tables at a summarized level using an outer join leveraging a foreign key. A distribution-based approach may include scaling normalized data to generate synthetic data for each join combination class at a merge level. A distribution-based approach may include denormalizing data per individual tables from a scaled merged table. For instance, individual tables may be retrieved by keeping only required individual table columns and a combination class. A distribution-based approach may include creating numerical and/or date values for each respective column of each table. This step may be implemented as described above with reference to FIG. 1, without limitation.

At step 215, the synthetic data generated from the first or second category of synthetic data generation is validated. Validation may be performed through a validation module. Validation may include evaluating a quality of the generated synthetic data. Quality may be measured by, but not limited to, variety, volume, and/or veracity, such as described above with reference to FIG. 1, without limitation. In an embodiment, if the synthetic data does not meet one or more requirements of variety, volume, and/or veracity, the data may be flagged by a computing device as low quality and may be re-generated. This step may be implemented as described above with reference to FIG. 1, without limitation.

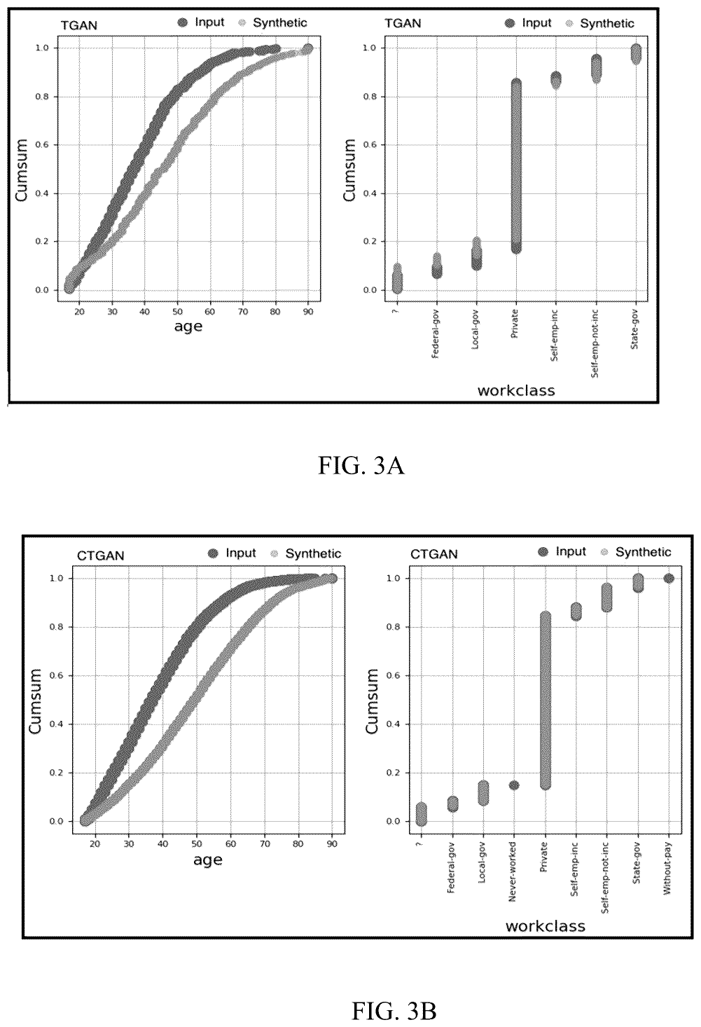

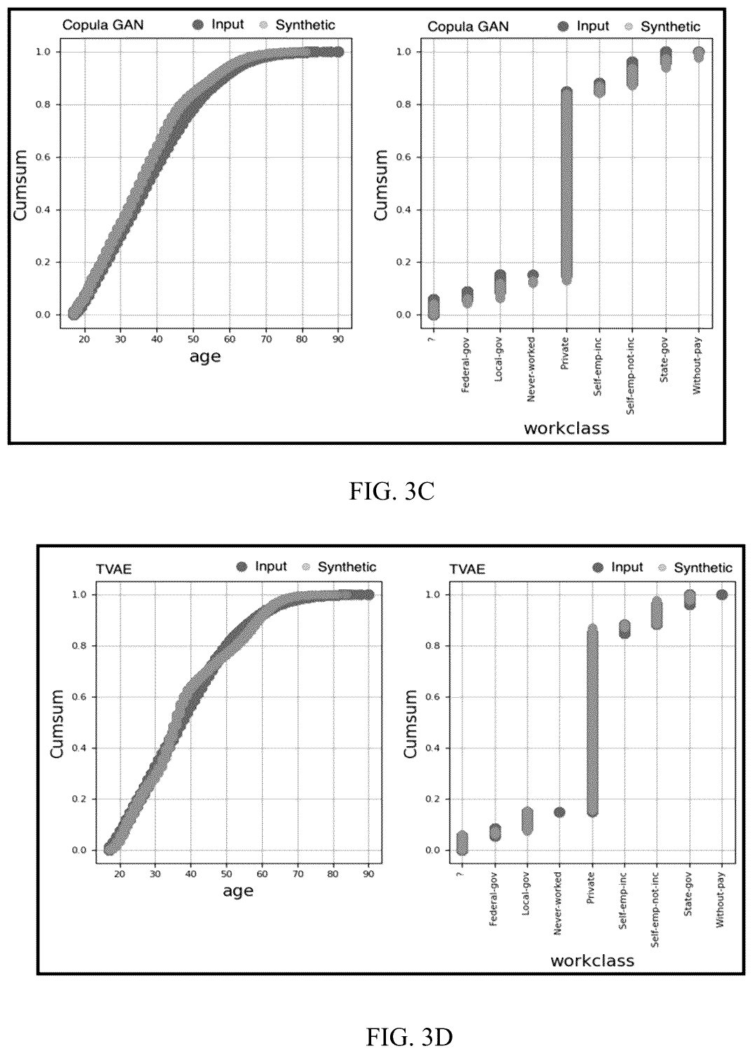

Referring now to FIG. 3A, two distribution graphs showing synthetic data generation of a TGAN model is shown. The first graph has an x-axis of “age” and a y-axis of “sum”, which is a cumulative sum total. Simply, the graph shows how many people of each age are in the data set. The second graph shows a distribution of age groups per job categorization, with an x-axis of “workclass” and a y-axis of “sum”. Here, the synthetic data produced from the TGAN model has a slightly different distribution than the input data.

Referring now to FIG. 3B, a graph showing synthetic data generation using a CTGAN is shown. The data is the same as that of FIG. 3A described above. Here, the CTGAN shows a larger difference in distribution from the input data compared to the synthetic data.

Referring now to FIG. 3C, a graph showing synthetic data generation using a Copula GAN is shown. The data is the same as described above in FIG. 3A. Here the Copula GAN retains the distribution of data closer to that of the original data.

Referring now to FIG. 3D, a graph showing synthetic data generation using a TVAE model is shown. The data is the same as described above in FIG. 3A. Here the TVAE has a synthetic data distribution output close to that of the input data.

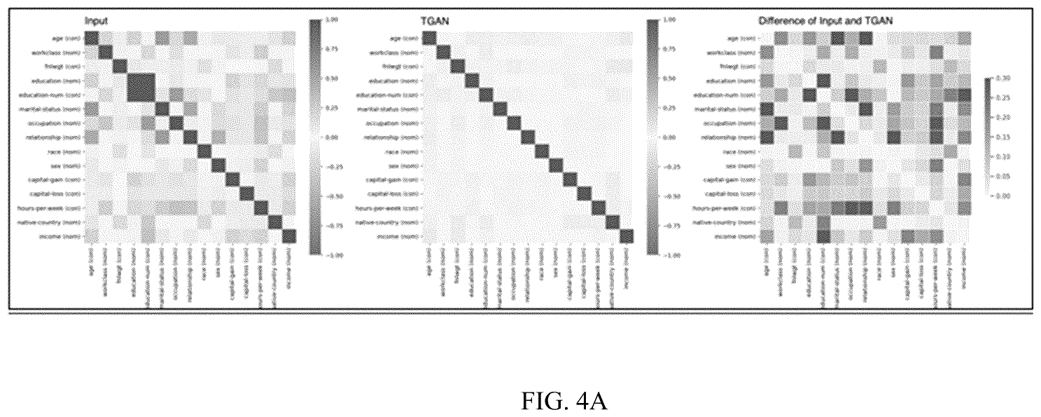

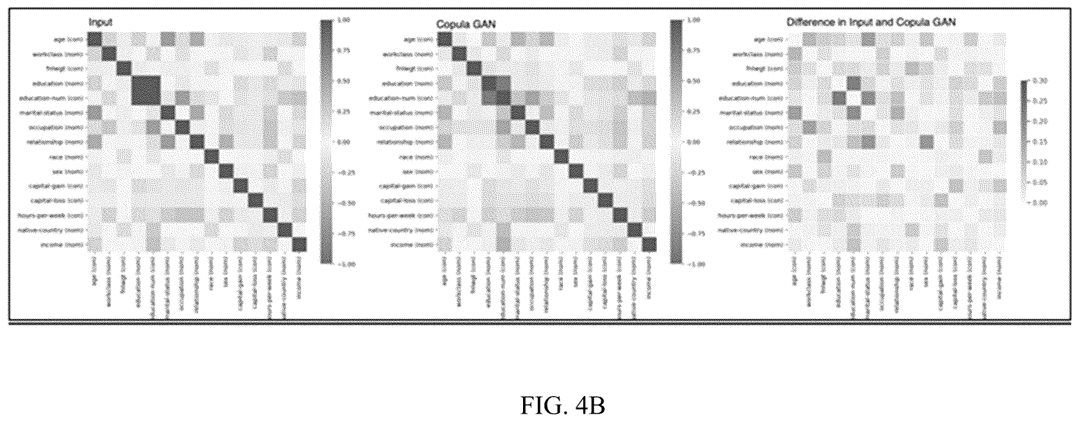

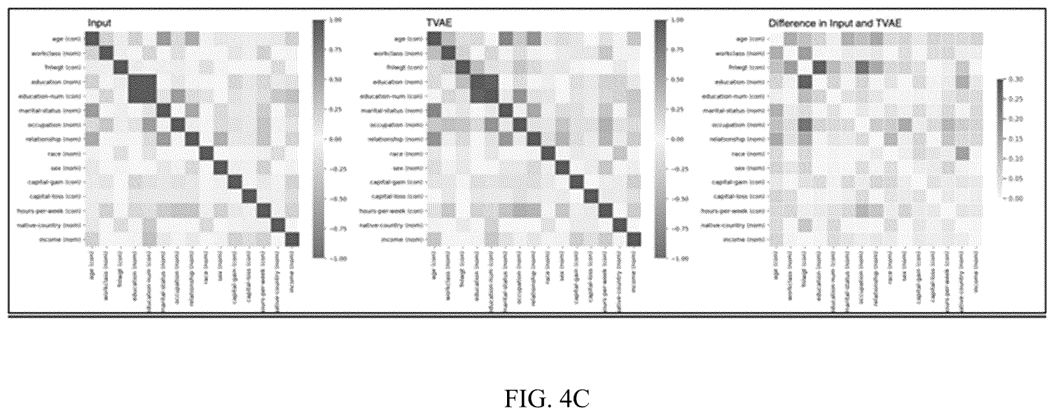

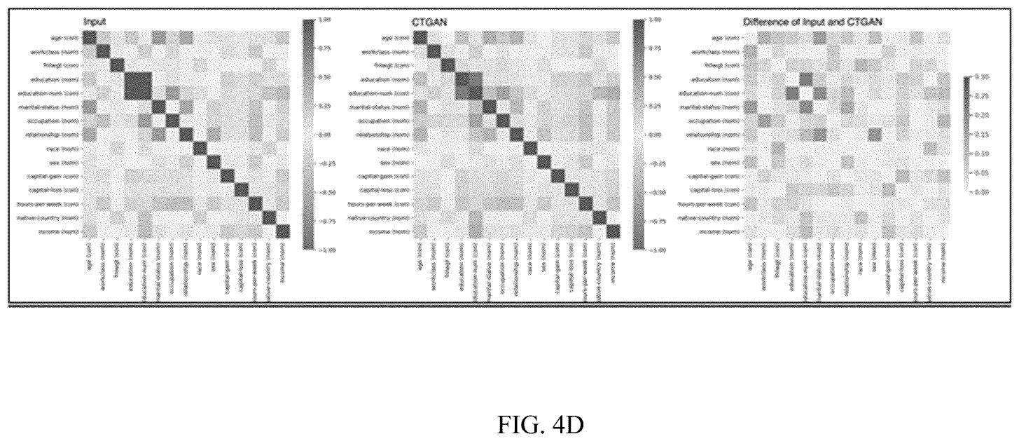

Referring now to FIG. 4A, a group of correlation matrices for synthetic data generated by a TGAN is shown. The first correlation matrix is simply a set of data representing intra-variable relationships for input data and synthetic data between various variables, such as age, workclass, fnlwgt, education, education-num, marital status, occupation, relationship, race, sex, capital gain, capital loss, hours per week, native country, and/or income. “fnlwgt” refers to a variable assigned by the U.S. Census Bureau that represents similarity between two or more samples. As a no-limiting example, sample 7, 12, and 33 may have similar fnlwgt values which may indicate that they are more likely to be of a same race, educational and social background, and the like. In some embodiments, “fnlwgt may be state specific such that a fnlwgt of a sample in Massachusetts may be different than a fnlwgt of the same sample but in California. The second correlation matrix shows the intra-variable relationships of the same variables but with data generated from the TGAN. The third correlation matrix shows the variability in the synthetic data generated by the TGAN in view of the original data.

Referring now to FIG. 4B, a correlation matrix for synthetic data generated by a CTGAN is shown. The first correlation matrix shows the same data as in the first correlation matrix of FIG. 4A. The second correlation matrix shows the intra-variable relationships of the same variables but with data generated from a CTGAN. The third correlation matrix shows the variability in the synthetic data generated from the CTGAN in view of the original data.

Referring now to FIG. 4C, a correlation matrix for synthetic data generated by a Copula GAN is shown. The first correlation matrix shows the same data as in the first correlation matrix of FIG. 4A. The second correlation matrix shows the intra-variable relationships of the same variables but with data generated from a Copula GAN. The third correlation matrix shows the variability in the synthetic data generated from the Copula GAN in view of the original data.

Referring now to FIG. 4D, a correlation matrix for synthetic data generated by a TVAE is shown. The first correlation matrix shows the same data as in the first correlation matrix of FIG. 4A. The second correlation matrix shows the intra-variable relationships of the same variables but with data generated from a TVAE. The third correlation matrix shows the variability in the synthetic data generated from the TVAE in view of the original data.

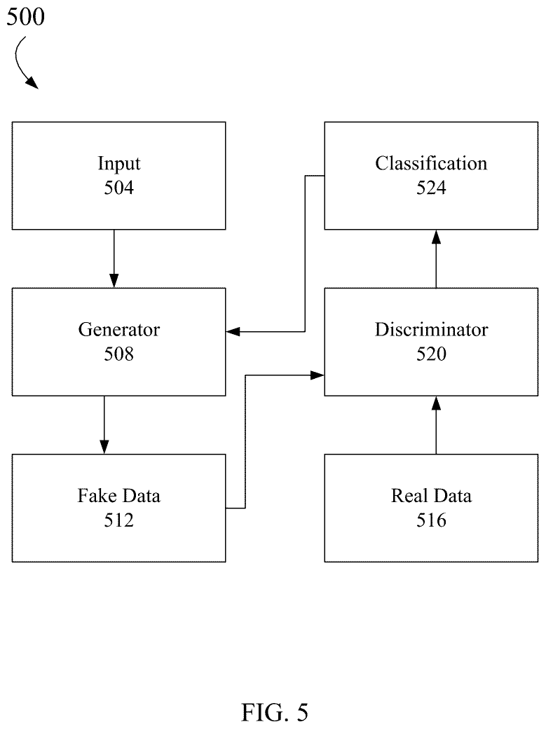

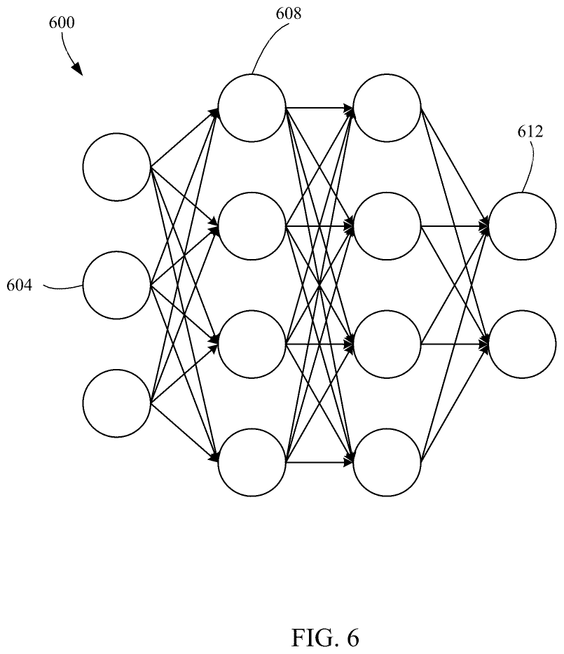

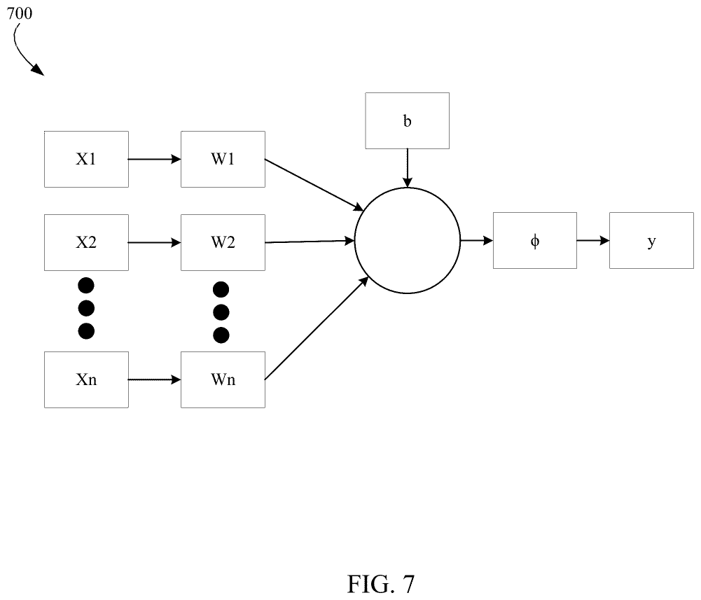

Referring now to FIG. 5, an exemplary embodiment of a general generative adversarial network (GAN) 500 is shown. The GAN 500 may include input 504. The input 504 may include any form of data, such as, but not limited to, text, images, data tables, and the like. The input 504 may be sent to the generator 508. The generator 508 may include one or more neural networks, such as described below with reference to FIGS. 6-7. The generator 508 may include one or more nodes, hidden layers, and the like. The generator 508 may be configured to create the fake data 512 based on the input 504. In some embodiments, random input (not shown) may be added to the generator 508, such as random noise which may be transformed by the generator 508 into a useful output. In some embodiments, random noise introduced into the generator 508 may be a uniform distribution or other distribution. An amount of random input may be selected by one or more users. The generator 508 may create the fake data 512 based on the input 504 or a combination of random noise with the input 504. The fake data 512 may include a same data type as the input 504, such as text, images, data tables, and the like. The fake data 512 may be communicated to the discriminator 520. In an embodiment, the output of the generator 508 may be directly sent as input to the discriminator 520. The discriminator 520 may be a neural network, and in some embodiments, may be a classifier. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A classifier may be generated using a classification algorithm, which may refer to a process whereby a processor derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

The discriminator 520 may be configured to generate classification 524 through one or more classification processes. The classification 524 may be a determination of a fakeness of the fake data 512. For instance, the classification 524 may output a “real data” or “fake data” determination/categorization of the fake data 512. For instance, and without limitation, the discriminator 520 may be configured to generate the classification 524 to assign the fake data 512 to a real or fake category. The discriminator 520 may utilize a loss function that may penalize the discriminator 520 for misclassifying real data as fake data or fake data as real data. A loss function, also known as a cost function, refers to a function that maps an event or values of one or more variables onto a real number representing some “cost” associated with the event. Here, a loss function of the discriminator 520 and/or the generator 508 may attempt to minimize a distance between a distribution of the fake data 512 and the real data 516. A loss function may include, but is not limited to, a quadratic loss function, a square loss function, a logistic loss function, an exponential loss function, a savage loss function, a tangent loss function, a hinge loss function, a generalized smooth hinge loss function, and the like.

The discriminator 520, through a loss function or other algorithm, may update one or more weights of itself. Weights may include weighted variables as described below with reference to FIGS. 6-7. The discriminator 520 may communicate values, weights, and the like, of to the generator 508, such as through backpropagation of the GAN 500. The generator 508, through feedback from the discriminator 520, may also utilize a loss function to update one or more weights of itself. In some embodiments, a loss function of the discriminator 520 and the generator 508 are the same. In other embodiments, a loss function of the discriminator 520 and the generator 508 may be different.

In some embodiments, the GAN 500 may utilize backpropagation through both the discriminator 520 and the generator 508 to obtain one or more gradients of a neural network. The GAN 500 may utilize one or more gradients to change one or more weights of the generator 508 and/or the discriminator 520. Through iterations of backpropagation and minimizations of loss functions, the GAN 500 may improve in generating authentic-seeming fake data 512. The GAN 500 may train the discriminator 520 and the generator 508 separately to reach convergence. In other words, the discriminator 520 may decrease in performance as the generator 508 increases in generating authentic-looking fake data 512. If the generator 508 succeeds in generating authentic-looking fake data 512, then the discriminator 520 may have a 50% accuracy in determining if the fake data 512 is fake or real through classification 524.

Referring now to FIG. 6, a neural network 600 is presented. A neural network as used in this disclosure is a data structure that is constructed and trained to recognize underlying relationships in a set of data through a process that mimics the way neurological tissue in nature, such as without limitation the human brain, operates. The neural network 600 includes a network of “nodes,” or data structures having one or more inputs, one or more outputs, and functions determining outputs based on inputs. Such nodes may be organized in a network, such as without limitation a convolutional neural network (CNN). The network of nodes may include an input layer of nodes 604, one or more intermediate layers 608, and an output layer of nodes 612. Intermediate layers 608 may also be referred to as “hidden layers”. Connections between nodes may be created via the process of “training” the neural network 600, in which elements from a training dataset are applied to the input nodes. A suitable training algorithm, such as without limitation Levenberg-Marquardt, conjugate gradient, simulated annealing, and/or other algorithms may be used to adjust one or more connections and weights between nodes in adjacent layers, such as the intermediate layers 608 of the neural network 600, to produce desired values at the output nodes 612. This process is sometimes referred to as deep learning.

Referring to FIG. 7, an exemplary neural network 700 is shown where nodes may include, without limitation a plurality of inputs xᵢ that may receive numerical values from inputs to a neural network containing the node and/or from other nodes. A node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

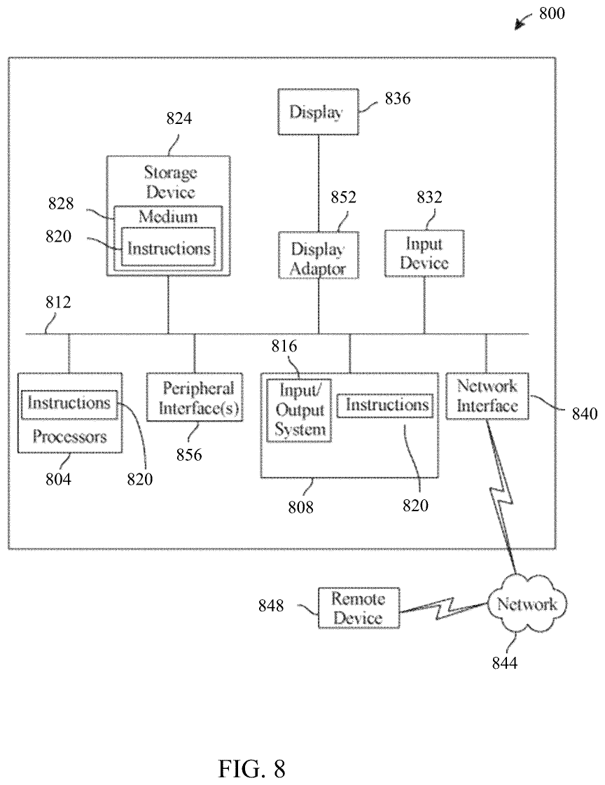

Referring now to FIG. 8, a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for synthetic data generation, comprising:
a processor; and
a memory communicatively connected to the processor, the memory containing instructions configuring the processor to:
receive data;
input the data into a generative framework, the generative framework comprising:
a plurality of categories of synthetic data generation, wherein the plurality of categories of synthetic data generation includes at least:
a first category of synthetic data generation; and
a second category of synthetic data generation, wherein the generative framework is configured to input data and output synthetic data through at least a category of synthetic data generation; and
generate, based on the generative framework, synthetic data from the received data.

2. The apparatus of claim 1, wherein the processor is further configured to validate an aspect of the synthetic data.

3. The apparatus of claim 2, wherein the aspect includes evaluation of one of veracity, variety, volume, or a combination thereof, of the synthetic data.

4. The apparatus of claim 1, wherein the first category of synthetic data generating methods includes a plurality of generative artificial intelligence architectures.

5. The apparatus of claim 1, wherein the first category of synthetic data generating methods includes a hierarchical modeling algorithm (HMA).

6. The apparatus of claim 5, wherein the processor is further configured to extract combination data of the data and feed the extracted combination data to the HMA as metadata.

7. The apparatus of claim 1, wherein the second category of synthetic data generation methods includes a distribution-based generation.

8. The apparatus of claim 1, wherein the synthetic data generated from the generative framework maintains referential integrity of the data.

9. The apparatus of claim 1, wherein the generative framework is further configured to generate a free text variable through a large language model (LLM).

10. The apparatus of claim 1, wherein the processor is further configured to:
receive user input, the user input including a selection of a category of synthetic data generating methods of the generative framework; and
generate the synthetic data through category of synthetic data generating methods selected from the user input.

11. A method of synthetic data generation using a computing device, comprising:
receiving data;
inputting the data into a generative framework, the generative framework comprising:
a plurality of categories of synthetic data generation, the plurality of categories of synthetic data generation includes at least:
a first category of synthetic data generation; and
a second category of synthetic data generation, wherein the generative framework is configured to input data and output synthetic data through at least a category of synthetic data generation; and
generating, based on the generative framework, synthetic data from the received data.

12. The method of claim 11, further comprising validating, by the processor, an aspect of the synthetic data.

13. The method of claim 12, wherein the aspect includes evaluation of one of veracity, variety, volume, or a combination thereof, of the synthetic data.

14. The method of claim 11, wherein the first category of synthetic data generation includes a plurality of generative artificial intelligence architectures.

15. The method of claim 11, wherein the first category of synthetic data generation includes a hierarchical modeling algorithm (HMA).

16. The method of claim 15, further comprising extracting, by the processor, combination data of the data and feeding the extracted combination data to the HMA as metadata.

17. The method of claim 11, wherein the second category of synthetic data generation includes a distribution-based generation.

18. The method of claim 11, wherein the synthetic data generated from the generative framework maintains referential integrity of the data.

19. The method of claim 11, further comprising generating a free text variable through a large language model (LLM) through the generative framework.

20. The method of claim 11, further comprising:
receiving user input, the user input including a selection of a category of synthetic data generation of the generative framework; and
generating the synthetic data through the category of synthetic data generation selected from the user input.
